(19) United States
(12) Patent Application Publication
(10) Pub. No.: US 2005/0060295 A1
(43) Pub. Date: Mar. 17, 2005

(54) Statistical classification of high-speed network data through content inspection

(75) Inventors: Stephen Gould, Queens Park (AU); Robert Matthew Barrie, Double Bay (AU); Darren Williams, Newtown (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sensory Networks, Inc., East Sydney (AU)

(21) Appl. No.: 10/661,384

(22) Filed: Sep. 12, 2003

(51) Int. Cl. G06F 17/30

(52) U.S. Cl. 707/3

(57) ABSTRACT

A network data classifier statistically classifies received data at wire-speed by examining, in part, the payloads of packets in which such data are disposed and without having a priori knowledge of the classification of the data. The network data classifier includes a feature extractor that extract features from the packets it receives. Such features include, for example, textual or binary patterns within the data or profiling of the network traffic. The network data classifier further includes a statistical classifier that classifies the received data into one or more pre-defined categories using the numerical values representing the features extracted by the feature extractor. The statistical classifier may generate a probability distribution function for each of a multitude of classes for the received data. The data so classified are subsequently be processed by a policy engine. Depending on the policies, different categories may be treated differently.

### CROSS-REFERENCES TO RELATED APPLICATIONS

The present Application is related to and hereby incorporates by reference U.S. application Ser. No. 10/640,870, Attorney Docket No. 021741 -000100US, filed on Aug. 13,2003, entitle “INTEGRATED CIRCUIT APPARATUS AND METHOD FOR HIGH THROUGHPUT SIGNATURE BASED NETWORK APPLICATIONS” in its entirety.

### FIELD OF THE INVENTION

The present invention relates to network communication systems, and more particularly to statistical classification of network data for signature-based security and quality-of-service.

### BACKGROUND OF THE INVENTION

Computer networks are an important part of infrastructure for enterprise communication systems. Both the content as well as timeliness of delivery of data flowing between computer networks have become increasingly important. Advances in computing and networking have enabled individuals across the globe to share information. FIG. 1 is a simplified high-level block diagram of a packet based network 10 coupled to network systems 15, 20, and 25. Network system 25 is also shown as coupled to a number of hosts 30 via a Local Area Network (LAN) 35. Network system 15 may include a look-aside gateway monitoring device such as a network monitor or intrusion detection system (not shown). Network system 20 may include a gateway system such as a router, firewall or switch (not shown) coupling LAN 35 to packet based network 10. Each host 30 may include a workstation, file server or mail server (not shown). Communication between various shown network systems 15, 20 and 25 including hosts 30 and packet based network 10 may be carried out via a number of known network protocols.

Data is often segmented into a number of packets before it is transmitted across a computer network, such as the Internet. The packets—each of which is adapted to carry a portion of the data—are then routed independently across the network from their source to their destination. Consequently, packets associated with the same data may be transmitted across different paths and arrive out of order. After arriving at their destination, the packets are reassembled to form the original data stream. FIG. 2 show a data stream 40 segmented into three packets 45 before transmission over a packet switched network such as the Internet. As shown in FIG. 2, each packet 45 has a payload or body 50—which carries a segment of data 45—and a header 55 which is used for routing and delivery of that packet 45 as well as for reassembly of the data 40 at the receiver.

FIG. 3 shows a TCP/IP packet 60 that includes a payload 65, a TCP header 70, and an IP header 80, as known in the prior art. TCP header 70 includes, in part, destination port 72 and source port 74. IP header 80 includes, in part, destination address 82, source address 84 and protocol 86. These five fields are commonly referred to as the TCP/IP or UDP/IP 5-tuple.

Packets are routed between computers using routing algorithms that enable, e.g., computers and network equipment to determine the routing path via which each packet is transmitted. To determine the routing path, such algorithms often examine the packet header at relatively high speeds. Some routing algorithms, in addition to examining the header, may search and examine the contents of the packet in deciding the routing path as well as the priority assigned to a packet. However, this additional examination often increases the delay incurred in determining a packet's routing path and thus limits the throughput.

Increasingly, as packets are sent across a network from their source to their destination they are examined not just to determine their routing decisions but for other purposes as well. For example, a series of packets carrying an e-mail message may be examined to determine whether the e-mail message is unwanted, commonly referred to as spam. Such examination often requires analysis of the payload portion of the packets that collectively form the e-mail message. Similarly the e-mail message may be analyzed to determine if it contains a computer virus. Packets may also be examined to offer a better quality of service or to search for illegal activities, such as, copyright infringements, computer hacking, or corporate espionage.

Network equipment configured to examine packet headers in a relatively short time period have been developed. However, examining a packet's payload in a relatively small window of time often poses difficulties. Such difficulties may be compounded by the fact that payloads are analyzed in context of data structures and protocols, and further in the face of malicious obfuscation by a sophisticated attacker. Conventional network appliances such as email gateways, intrusion detection systems and general content protection appliances typically search the network data via software. These software-based network appliances, while flexible, may not operate at the desired speeds. In other words, they often have long delays and small throughput. Other conventional hardware-based network appliances can only examine a packet's header to decide the packet's routing channel. Furthermore, these software-based and hardware-based network appliances typically impose a number of restrictions on the data that can be searched for, and the number of different patterns that can be matched simultaneously.

Network equipment must meet the timing constraints defined by the standards or required by the user. For example, the total travel time of a packet from an ingress interface to an egress interface needs to be kept to a minimum. The time it takes for a packet to travel through a communication device or channel is called latency. The latency so introduced must not only be kept to a minimum, but must also be kept relatively constant. The change in latency is commonly referred to as jitter and is known to adversely affect multimedia data streams. In existing software-based network appliances, jitter is difficult to control because the associated software modules in which the codes are disposed are often executed by a single CPU that is shared with many other processes or applications. The problems may be further compounded by the fact that most general purpose operating systems do not provide support for real-time processing. As a result, software application interactions can have detrimental effect on network performance. As networks run faster, this effect is compounded.

As is known to those skilled in the art, associated packets may not always arrive in the same order in which they are transmitted. Moreover, packets may end up being segmented due to a variety of reasons. Accordingly, the receiving end of a data stream may need to reassemble the fragmented packets—notwithstanding the order of their arrival—using networking algorithms. Such segmentation and reassembly algorithms often impose additional restrictions on the network appliances or applications adapted to examine the stream of data in its full context. Decision regarding, e.g., routing of a packet are typically done using the information disposed in the packet. However, search and identification of a particular pattern may span across two or more packets. Thus, searching for a pattern in multiple packets may require a technique or algorithm designed to handle fragmented and out of order packets.

Searching for textual or binary patterns within network traffic may be used to identify different categories of data. For example, scanning email messages for virus signatures may be used to identify potentially hostile attachments. However, detecting a pattern within a data stream may lead to uncertainties. As known to those skilled in the art, the terms false-positive and false-negative are used to refer to misclassification of data when trying to detect a particular category or class, as seen in the confusion matrix shown in Table I below.

TABLE I

| | Positive Data | Negative Data |
|---|---|---|
| Classified | True Positive | False Positive |
| Positive | | |
| Classified | False Negative | True Negative |
| Negative | | |

As seen from the above confusion matrix, a false-positive results if data is incorrectly classified as falling within a particular category, and a false-negative results if data is incorrectly classified as not falling within a particular category. The confusion matrix may be extended to multiple category classification. A classifier's performance may be controlled by trading off sensitivity with specificity. A classifier which is more sensitive, has a relatively higher rate of false-positive and a relatively lower false-negative rate. A classifier which is more specific, has a relatively lower rate of false-positives and a relatively higher rate of false-negative. In other words, a classifier which is more sensitive, classifies more data positively and therefore misclassifies more negative data (higher false-positive rate). Conversely, a classifier which is more specific, misclassifies more positive data (higher false-negative rate).

Statistical classification of data involves extraction of some features from the data. During feature extraction, a set of attributes, sufficient to classify the data into one or more of the target categories with some certainty, is identified in the data. For example, a spam classifier may have a feature extractor adapted to count the number of times a particular word or a group of words appear within the email message. Another spam classifier may have a feature extractor adapted to determine whether the sender is known to the recipient. Such feature extractors may be combined to provide a more robust classification.

Feature extraction is also of use when essentially the same information is represented in various forms of data. For example, a relatively simple comparison of two multimedia streams coded in different formats may not provide a reliable method for classification. By extracting features using statistical classification, the robustness with which classification is performed increases. Statistical classifiers also provide more information to applications designed to enforce system policies. Therefore, using statistical classification, such applications may be made more intelligent by allowing smooth cut-offs, since the probabilities and confidence intervals are known.

A number of different types of statistical classifier have been developed. These applications are often run in software and have limited hardware support. Accordingly, because of networking issues affecting latency and throughput described above, conventional software-based statistical classifiers have limited performance.

There is a need for a system and method adapted to provide feature extraction and statistical classification of network data at network speeds, that does not suffer from limitation regarding the size and complexity of the features that it may extract, and that does not substantially affect the network performance.

### BRIEF SUMMARY OF THE INVENTION

In accordance with one embodiment of the present invention, network data are statistically classified at wire-speed by examining, in part, the payloads of packets in which such data are disposed and without having a priori knowledge of the classification of the data Wire-speed is understood to refer to the speed (i.e., rate) at which packets are received from the network. Packet are understood to include, for example, cells, frames, blocks, etc. Network data includes, for example, streams, files, and messages, etc.

In one embodiment, the wire-speed network data classifier includes, in part, a network interface, a feature extractor, a statistical classifier, and a policy engine. The feature extractor extract features (i.e., attributes) from the packets it receives from the network interface. Such features include, for example, textual or binary patterns within the data and may be represented by regular expressions. Such features may also include profiling of the network traffic and observing of flags and settings disposed in the packet headers. Such a profiling includes, for example, information related to indicator vector, histogram, statistics, mathematical transformation, timing information, and network events.

The statistical classifier is configured to receive the numerical values representing the features extracted by the feature extractor as to classify the received data into one or more pre-defined categories. The statistical classifier may be configured to generate a probability distribution function for each of a multitude of classes for the received data. The data so classified may subsequently be processed by the policy engine 240 in accordance with policies (i.e., rules) programmed therein. Depending on the policies of the associated application, different categories may be treated differently.

In another embodiment, the wire-speed network data classifier, in addition to the components described above, includes a flow identifier and a flow assembler. The received packets are identified as belonging to a particular data flow in accordance with the protocols associated with the network via which the packets are transmitted. The flow identifier associates one or more of the incoming packets with a particular data flow so that the packets may be analyzed and classified as a single data flow. The flow assembler, in part, maintains a flow database record containing information related to each active data flow and reassembles data into its original order as specified by the network protocol. In yet another embodiment, the wire-speed network data classifier, in addition to the components described above, includes a host interface adapted to communicate with a host system such as network processing unit and/or a microprocessor, or a flow multiplexer to enable context switching.

In some embodiments, the statistical classifier classifies the received data in accordance with a linear discriminant classifier. In these embodiments, the data may be classified into two or more pre-determined classifications (categories) depending on the application. The feature extractor may also be adapted to extract numerical values associated with the attributes of the received data.

In some other embodiments, the statistical classifier classifies data into one or more categories using a multi-layer artificial neural network. The weights within the neural network, and non-linear activation function associated with each node is determined offline during a training phase. In some other embodiments, the statistical classifier may include a decision tree classifier or a support vector machine (SVM). A network content classification system with an SVM classifier system may be trained to determine the decision boundary that provides the greatest margin between various classes to which the data may belong. The SVM is trained to optimally separate classes based on some criteria, and the decision boundary is determined in association with the training. Once trained, the SVM uses the parameters determined during the training phase to classify new data. Various training algorithms have been developed for selecting support vectors and determining the pertinent coefficients t. In some embodiments, the classification of the received data is made, in part, using a decision function. The decision function is subsequently used to determine the class to which the data belongs.

The kernel function, between the pre-determined support vectors of a SVM, and the feature vectors associated with the data undergoing classification may be chosen from a number of known functions, such as a polynomial kernel function, a piece-wise linear kernel function, a sigmoid kernel function, a Gaussian radial basis function, and an exponential radial basis function.

In some embodiments, the statistical classifier may include a Bayesian network classifier that enables the modeling and reasoning about uncertainty of events. A Bayesian network allows the incorporation of both subjective and objective probabilities, where objective probabilities are obtained from analysis of training data, and subjective probabilities are predetermined. A typical Bayesian Network consists of multitude of nodes connected by links. The nodes represent observed features within the data, and the links represent conditional probabilities between these features. In yet other embodiments, the statistical classifier may be a nearest neighbor classifier. The nearest neighbor classifier stores all labeled training samples in a database and computes a distance metric between the feature vectors of each sample stored in the database and a given feature vector of an unknown data. The training sample closest to the feature vector of the unknown data is used to classify the data.

In some embodiments, the statistical classifier may include a number of statistical classifiers, known in the art as a mixture of experts classifier (MoE). Each individual classifier of an MoE is adapted to classify a particular subset of data and supply the classification to an arbiter. The arbiter, using the received classifications, decides the classification of the data. In some embodiments, the statistical classifier includes, in part, the following logic blocks: a weight look-up table, an adder, a multiplexer, an accumulator, a storage block, e.g., a register, and a non-linear transform logic block, each of which operates at wire-speed.

### BRIEF DESCRIPTION OF THE DRAWINGS

FIG. 1 is a simplified high-level block diagram of a typical computer network, as known in the prior art.

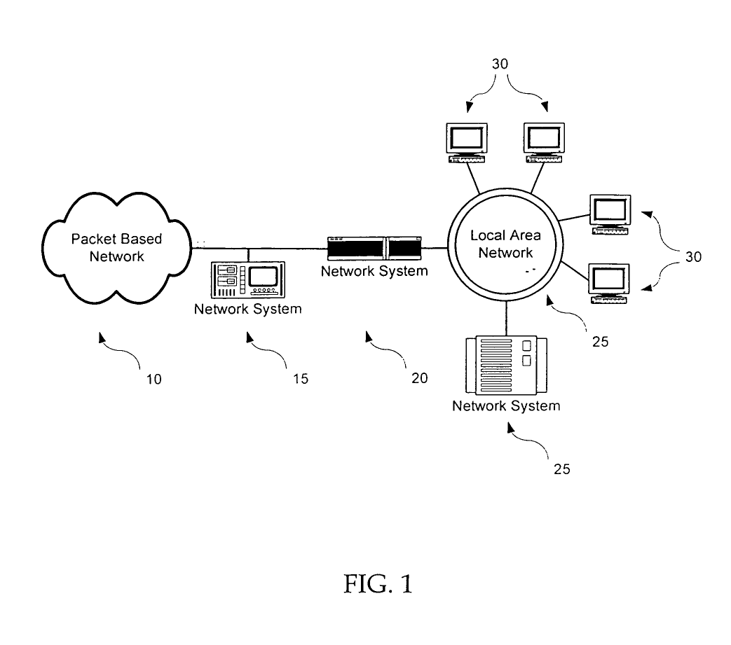

FIG. 2 shows a data stream segmented to be carried by a number of packets, as known in the prior art.

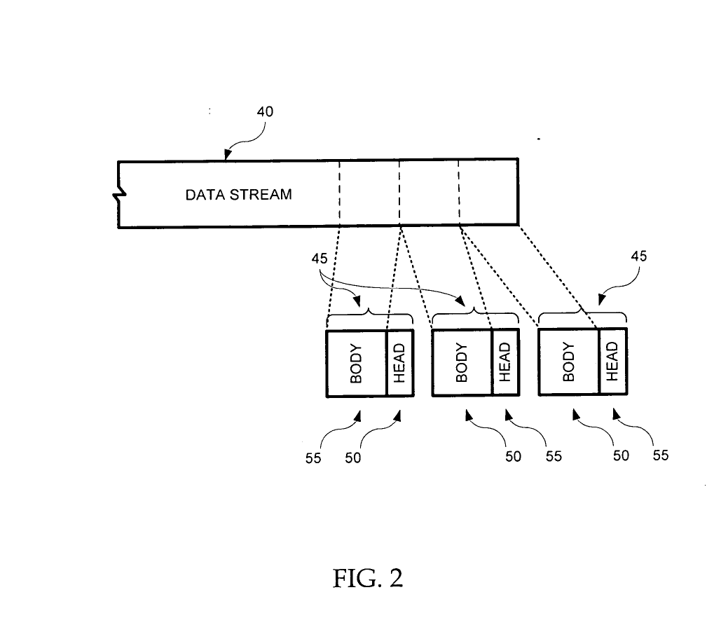

FIG. 3 shows various fields of the TCP/IP packet, as known in the prior art.

FIG. 4 shows various blocks of a wire-speed network data classifier, in accordance with one embodiment of the present invention.

FIG. 5 shows various blocks of a wire-speed network data classifier, in accordance with another embodiment of the present invention.

FIG. 6 shows various records stored in the flow database shown in FIGS. 5, in accordance with another embodiment of the present invention.

FIG. 7 shows various blocks of a wire-speed network data classifier, in accordance with another embodiment of the present invention.

FIG. 8 shows various blocks of a wire-speed network data classifier, in accordance with another embodiment of the present invention.

FIG. 9 shows an example of a one-dimensional linear discriminant classification, as known in the prior art.

FIG. 10 is a simplified view of various nodes and arcs of an artificial neural network, as known in the prior art.

FIG. 11 shows various data mapped into a two-dimensional space and classified using a linear support vector machine classifier.

FIG. 12A-12F shows various kernel functions which may be used in artificial neural network of FIG. 10 or the support vector machine classifier of FIG. 11.

FIG. 13 shows a decision tree, as known in the prior art.

FIG. 14 various transitions of a Bayesian network classifier, as known in the prior art.

FIG. 15 is a simplified schematic representation of a mixture of experts classifier, as known in the prior art.

FIG. 16 is a simplified high-level hardware logic blocks of a wire-speed network data classifier, in accordance with one embodiment of the present invention.

### DETAILED DESCRIPTION OF THE INVENTION

In accordance with one embodiment of the present invention, network data are statistically classified at wire-speed by examining, in part, the payloads of packets in which such data are disposed and without having a priori knowledge of the classification of the data It is understood that the wire-speed refers to the speed (i.e., rate) at which packets are received from the network, for example, greater than or equal to 100 Mbits/sec. It is also understood that a packet includes, for example, cells, frames, blocks, etc. It is further understood that network data includes, for example, streams, files, and messages, etc.

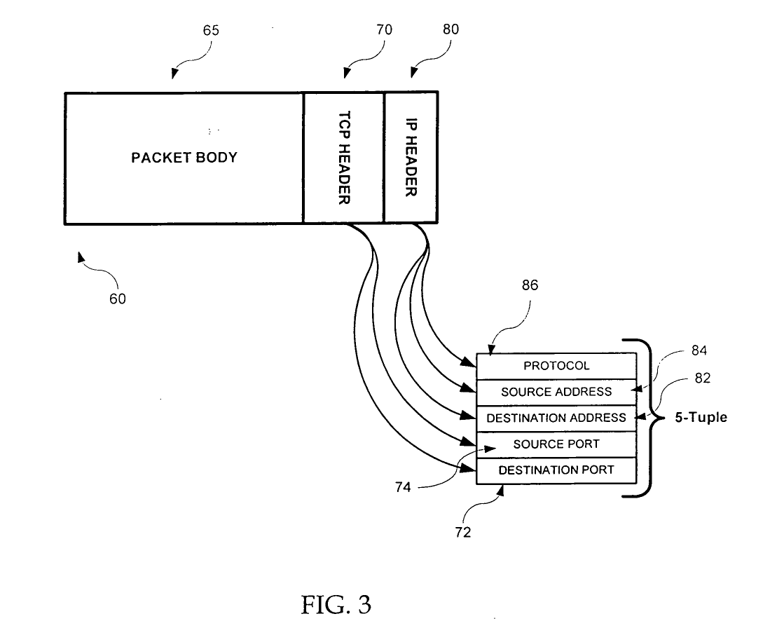

FIG. 3 shows various blocks of a wire-speed network data classifier 100, in accordance with one embodiment of the present invention, that is configured to classify the packets it receives from packet based network 10. Wire-speed network data classifier 100 includes, in part, a network interface 110, a feature extractor 120, a statistical classifier 230, and a policy engine 240.

Network interface unit 110 is configured, in part, to receive packets from network 10 and deliver the received packets to feature extractor 120. Feature extractor 120 is configured to extract features (i.e., attributes) from the packets it receives from network interface 110. Such features include, for example, textual or binary patterns within the data and may be represented by regular expressions. Such features may also include profiling of the network traffic and observing of flags and settings disposed in the packet headers. Such a profiling includes, for example, information related to indicator vector, histogram, statistics, mathematical transformation, timing information, and network events. It is understood that such features may be application dependent and programmable. Network 10 may be, for example, an Ethernet network, a SONET network, an ATM network, an Internet Protocol (IP) network, or any other packet-based network.

The features extracted by feature extractor 120 may be aggregated into a single feature or a feature vector—all of which are represented numerically. Each packet header flag may also be represented by a variable. Such a variable may be assigned a value of, e.g., 0 if no flag is present, and a value of, e.g., 1 if a flag is present. Such variables are commonly referred to as indicator variables.

Statistical classifier 130 is configured to receive the numerical values representing the features extracted by feature extraction unit 120 so as to classify the received data into one or more pre-defined categories. Statistical classifier 130 may be configured to generate a probability distribution function for each of a multitude of classes for the received data. The data so classified may subsequently be processed by policy engine 240 in accordance with policies (i.e., rules) programmed therein. Depending on the policies of the associated application, different categories may be treated differently. For example, in a network intrusion detection system (NIDS), hostile traffic may be dropped by the system, whereas friendly traffic is allowed to pass. Accordingly, in such situations, wire-speed network data classifier 100 may be configured to classify network data into either hostile or friendly categories. It is understood that in other situations, depending on the application type, other actions may be taken by wire-speed network data classifier 100. It is also understood that statistical classifier 130 may classify data for any number of applications, such as intrusion detection, intrusion prevention, fire walling, content filtering, access control, antivirus, network monitoring, traffic filtering, spam filtering, content classification, content protection, application-level switching, surveillance, XML web services, bandwidth management, biometric identification, stream classification, quality of service provisioning, and network management.

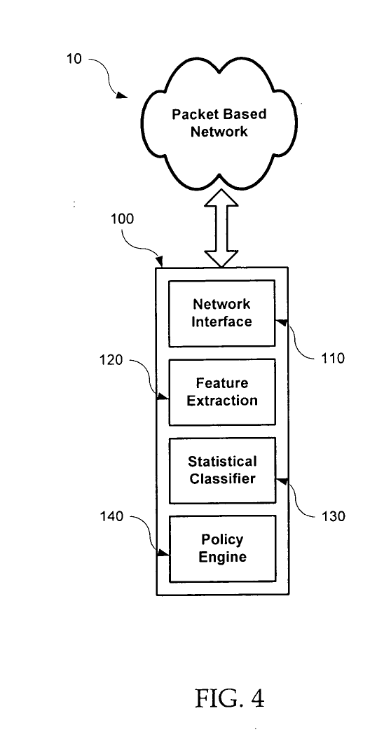

FIG. 4 shows various blocks of a wire-speed network data classifier 200, in accordance with another embodiment of the present invention. Wire-speed network data classifier 200 is configured to classify the packets it receives from packet based network 10. Wire-speed network data classifier 200 includes, in part, network interface 110, feature extractor 120, statistical classifier 130, policy engine 140, flow identifier 150 and flow assembler 160. In the following it is understood that blocks identified with similar reference numeral in various embodiments of the present invention operate similarly, therefore, for simplicity may only be described once. For example, network interface 110, feature extractor 120, statistical classifier 130 and policy engine 140 of wire-speed network data classifier 200 operate in the same manner as were described above in connection with wire-speed network data classifier 100, and therefore may not be described below.

The packets received by network interface 110 are identified as belonging to a particular data flow in accordance with the protocols associated with network 10. For example, under the TCP/IP network protocol, the data flow to which a packet belongs may be uniquely identified using a source address field, source port field, destination address field, destination port field, and protocol field, as seen in FIG. 3. Flow identifier 150 is configured to associate one or more of the incoming packets with a particular data flow so that the packets may be analyzed and classified as a single data stream. Flow assembler 160 reassembles data into its original order as specified by the network protocol. Flow assembler 160 maintains a flow database record 170 which contains information related to each active data flow. A data flow need not to be reassembled in its entirety before being processed by feature extractor 120, statistical classifier 130, and policy engine 140. Flow assembler 160 operates to ensure other blocks within wire-speed network data classifier 200 process any given data flow in the same order as that used to generate the data flow. The various blocks disposed in wire-speed network data classifier 200 may interrupt and suspend the processing of one data flow so as to process another data flow and thus to enable context switching. When such an interruption occurs to switch processing from one data flow to another data flow, information regarding the interrupted data flow is stored in flow database 270 so as to allow the processing to resume at a later time.

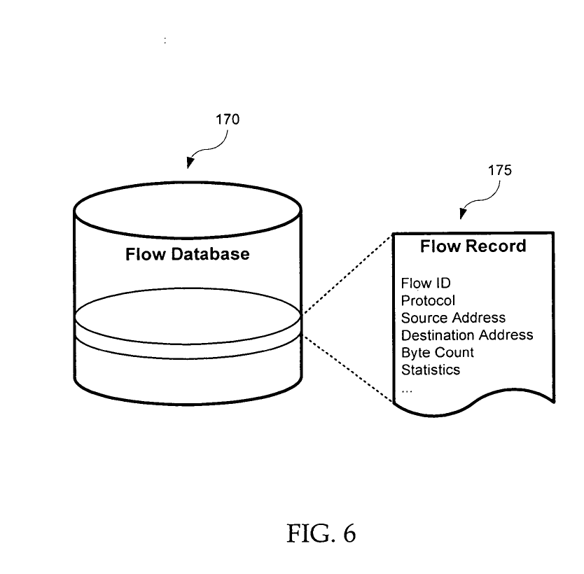

As seen in FIG. 6, flow database 170 includes a flow record 180 that contains information about each data stream. This information is used in stream reassembly, generation of network events, and feature extraction. Flow record 180 is shown as containing information about the flow ID, protocol, source address, destination address, byte count, statistics. It is understood that flow record 180 may contain more information than that shown in FIG. 6. Any information related to feature extraction or classification is stored in a corresponding flow record 180 of an associated data stream. For example in calculating the mean packet size of the packets, the sum of the sizes for all processed packets and their numbers is stored in flow record 180. The mean packet size may then be computed at any time by dividing the stored sum by the number of processed packets.

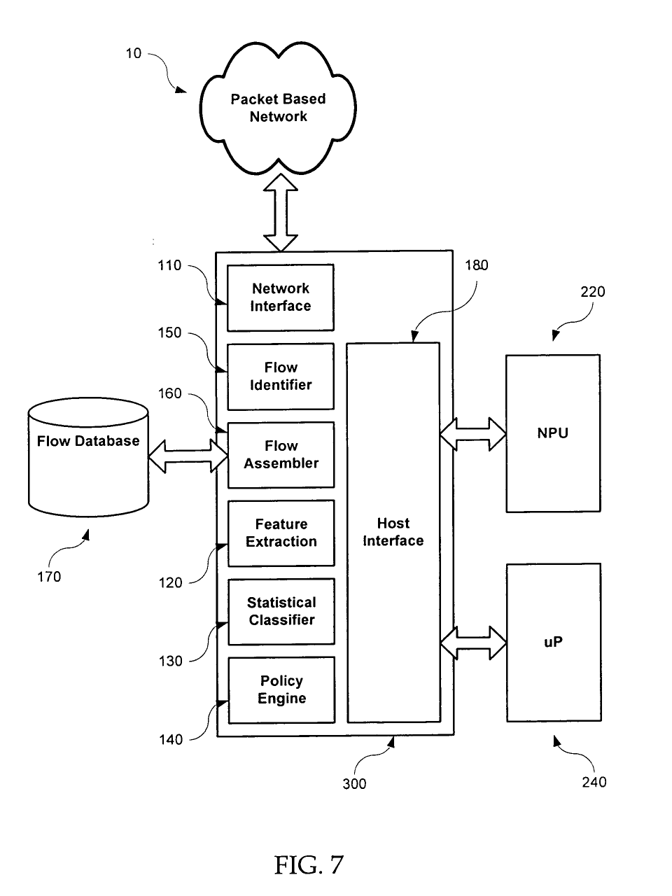

FIG. 7 shows various blocks of a wire-speed network data classifier 300, in accordance with another embodiment of the present invention. Wire-speed network data classifier 300 is configured to classify packets it receives from packet based network 10. Wire-speed network data classifier 300 includes, in part, network interface 110, feature extractor 120, statistical classifier 130, policy engine 140, flow identifier 150, flow assembler 160, and a host interface 180. Host interface 180 is adapted to communicate with a host system such as network processing unit (NPU) 220 and/or a microprocessor 240. Host interface 180 is further adapted to receive packets via such host systems and deliver these packets to other blocks (modules) disposed in wire-speed network data classifier 300. In some embodiments, NPU 220 or microprocessor 240 may include hardware/software modules adapted to perform such functions as packet identification, data flow reassembly, feature extraction, statistical classification, or policy implementation. In yet other embodiments, NPU 220 or microprocessor 240 may include hardware/software modules adapted to perform statistical classification or implement policy rules. It is understood that one or more application programming interfaces (APIs) may be used to establish communication across between host interface 180 and each of NPU 220 or microprocessor 240. Network interface 110, feature extractor 120, statistical classifier 130, policy engine 140, flow-identifier 150 and flow assembler 160 of wire-speed network data classifier 300 operate in the same manner as were described above in connection with wire-speed network data classifier 200, and therefore may not be described below.

In some embodiments of the invention, statistical classifier 130 is configured to correlate events between one or more data flows. For example, a port scan attempted by a potential intruder identifies which ports are open on a target machine by trying to connect to each port. Each connection is attempted in a separate data flow. In this situation, statistical classifier 130 correlates events between these flows to detect that port scanning is occurring. Thus, the data being classified by statistical classifier 130 is not restricted to single packets, flows, emails, files, etc., but includes groups of packets, flows, and even entire network connections.

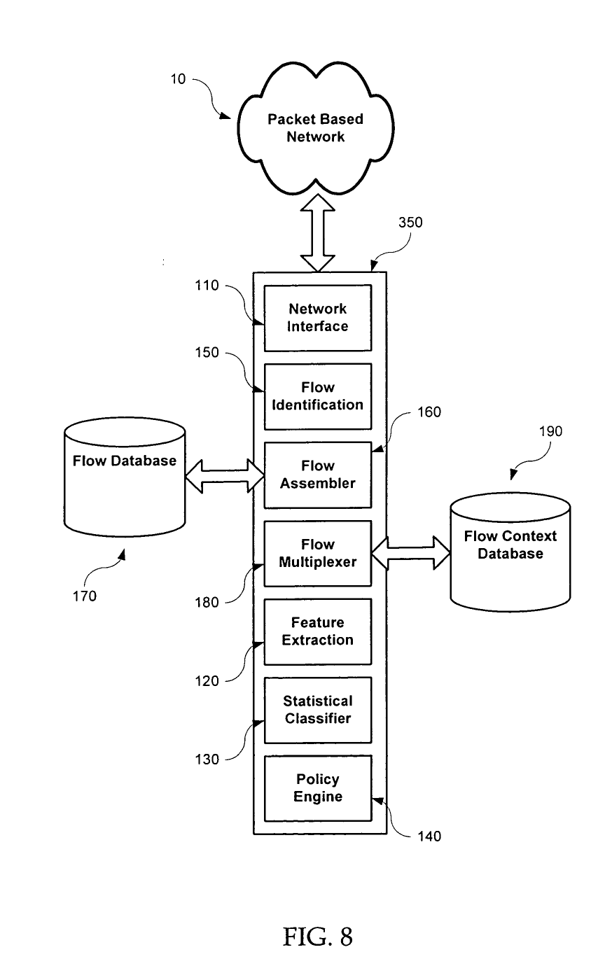

FIG. 8 shows various blocks of a wire-speed network data classifier 350, in accordance with yet another embodiment of the present invention. Wire-speed network data classifier 350 is configured to classify packets it receives from packet based network 10. Wire-speed network data classifier 300 includes, in part, network interface 110, feature extractor 120, statistical classifier 130, policy engine 140, flow identifier 150, flow assembler 160, and flow multiplexer 180. Network interface 110, feature extractor 120, statistical classifier 130, policy engine 140, flow-identifier 150 and flow assembler 160 of wire-speed network data classifier 350 operate in the same manner as described above. Flow multiplexer 180, which is coupled to flow assembler 160, is configured to provide switching between one or more data flows. Flow multiplexer 180 is also coupled to flow context database 190 which store information regarding the states of previous data flows. This enables processing of a previous data flow to resume at a later time. The following descriptions apply to all three embodiments, i.e., wire-speed network data classifiers 100, 200, and 300.

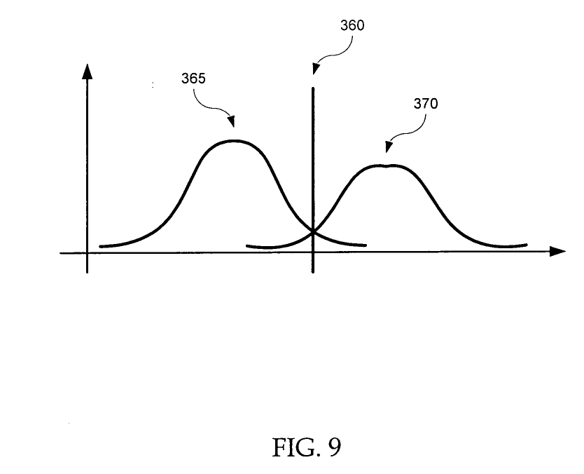

In some embodiments, statistical classifier 130 classifies received data in accordance with a linear discriminant classifier. In these embodiments, the data may be classified into two or more pre-determined classifications (categories) depending on the application. For example, an anti-spam classifier may classify emails into either spam or non-spam. Referring to FIG. 9, spam e-mails may be represented by probability distribution function 365, and non-spam e-mails may be represented by probability distribution function 370. The decision boundary 360 between these two distributions may be computed using a linear discriminant algorithm. The received e-mail may thus be classified in accordance with the following expression:

$$ϖ = \{ \begin{matrix}spam & {L}_{Y} ( y \vert spam ) \geq {L}_{Y} ( y \vert non \text{-} spam ) \\ non \text{-} spam & otherwise\end{matrix} \qquad ( 1 )$$

where \overline{ω} is the class and L_{Y}(y|\overline{ω}) is the pre-determined log-likelihood function of the distribution representing the given class.

As described above, feature extractor 120 is adapted to extract numerical values associated with the attributes of the received data. For an M-dimensional linear discriminant classifier, the extracted features may be formulated into an N-dimensional vector x which is transformed in accordance with the following:

$$[ \begin{matrix}{y}_{1} \\ {y}_{2} \\ ⋮ \\ {y}_{M}\end{matrix} ] = [ \begin{matrix}{u}_{1}^{T} x \\ {u}_{2}^{T} x \\ ⋮ \\ {u}_{M}^{T} x\end{matrix} ] - μ \qquad ( 2 )$$

where uᵢ is an N-dimensional projection vector whose coefficients correspond to the relative weights (positive or negative) of extracted features (i.e., attributes) represented by vector x, and μ is an M-dimensional vector corresponding to the mean of linear discriminants vector y. Both uᵢ and μ are established during the training phase.

In some embodiments, in applications that may be represented by two linearly separable classes, such as that used for spam classification, uᵢ and μ are selected such that

$$ϖ = \{ \begin{matrix}spam & {u}_{1}^{T} x - μ \geq 0 \\ non \text{-} spam & otherwise\end{matrix} \qquad ( 3 )$$

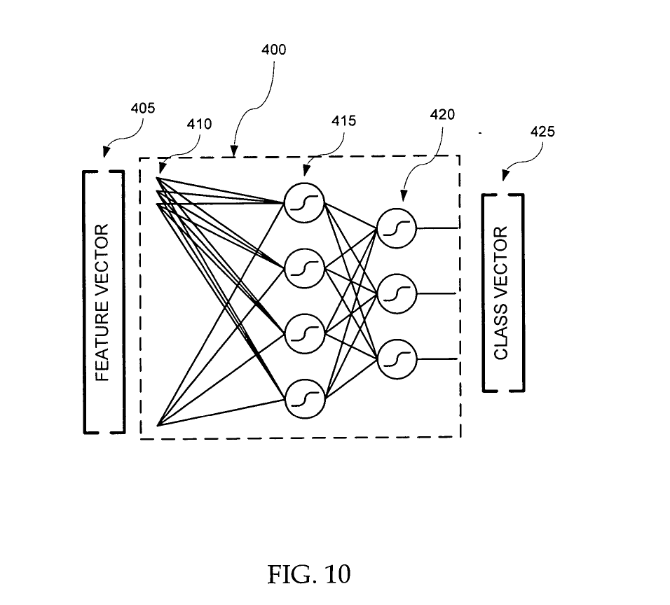

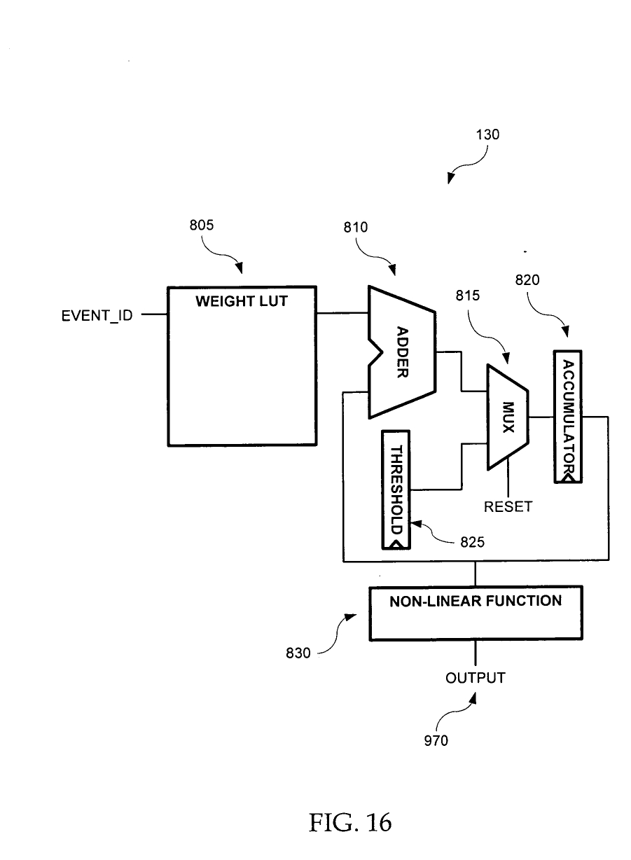

In some other embodiments, statistical classifier 130 classifies data into one or more categories using a multi-layer artificial neural network (ANN) 400, show in FIG. 10. In such embodiments, feature vector 405—that is formed using numerical attributes extracted by feature extractor 120—is supplied as input layer 410 to ANN 400. The weights within the neural network, and non-linear activation function associated with each node is determined offline during a training phase. Each node in the neural network may generate an output y according to the following non-linear activation function ƒ(·) of the weighted sum of the inputs:
y=ƒ(w^{T}x−μ) (4)
where x is the N-dimensional input vector, w is the N-dimensional weight vector, μ is the node's threshold, and ƒ(·) is the non-linear activation function. If feature vector 405 is formed using a histogram of events, hardware circuitry such as that shown in FIG. 16—described below—may be used to accelerate calculations for layer 415 in which most of the computational overhead lies.

Output layer 420 is shown as generating a vector that is used by class vector 425 to indicate the class to which the data packet belongs. In one embodiment, the index of entry in the output vector with the greatest value indicates the class. Thus for 3-dimensional output vector 420, class \overline{ω} is defined as shown below:

$$ϖ = \{ \begin{matrix}class 1 & {y}_{1} > {y}_{2} , {y}_{3} \\ class 2 & {y}_{2} > {y}_{1} , {y}_{3} \\ class 3 & otherwise\end{matrix} \qquad ( 5 )$$

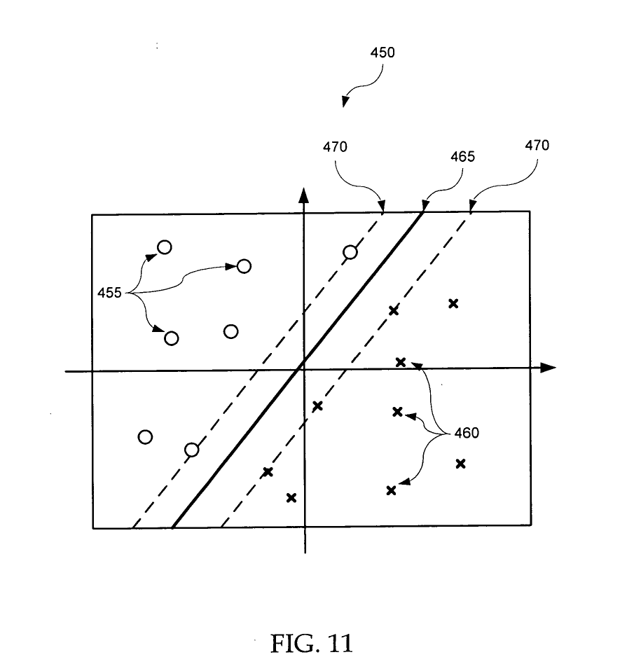

In accordance with other embodiments, statistical classifier 130 may include a support vector machine (SVM). FIG. 11 shows data mapped into a two-dimensional space 450 and classified using a linear SVM. As seen from FIG. 11, in two-dimensional space 450 data corresponding to a first class is denoted by small circles 455 (o), and data corresponding to a second class is denoted by crosses 460 (x). The SVM is shown as forming a decision boundary 465 which separates the two classes in accordance with a classifier margin 470 that is defined by the support vectors associated with each class.

A network content classification system with an SVM classifier system may be trained to determine the decision boundary that provides the greatest margin between various classes to which the data may belong. For example, in reference to FIG. 11, an SVM classifier may be trained to determine decision boundary 465 that provides the greatest margin 470 between positive training features—e.g., those identified with reference numeral 445, such as spam—and negative training features—e.g., those identified with reference numeral 470, such as non-spam. The pre-determined decision boundary may be characterized as a function of the support vectors. The SVM is trained to optimally separate classes based on some criteria, and decision boundary 465 is determined in association with the training. Once trained, the SVM uses the parameters determined during the training phase to classify new data. Various training algorithms have been developed for selecting support vectors and determining the coefficients that are defined below in equation 6.

In some embodiments, the classification of the received data is made, in part, using a decision function D(x) shown below:

$$D ( x ) = {\sum }_{∀ {x}_{i} ∈ S} {α}_{i} {λ}_{i} K ( {x}_{i} , x ) + {α}_{0} \qquad ( 6 )$$

where x represent the extracted feature vectors, αᵢ represent the weights (Lagrange multipliers) of the trained support vector weights, λᵢ represent predetermined class values, for example, +1 is assigned to data from the positive class, and −1 is assigned to data from a negative class. For a more discussion of SVMs, see, for example, “A Tutorial On Support Vector Machines for Pattern Recognition”, by Christopher J. C. Burges, Bell Laboratories, Lucent Technologies”, or “An Introduction to Kernel-Based Learning Algorithms”, by Klaus-Robert Muller, Sebastian Mika, Gunnar Ratsch, Koji Tsuda, Bernhard Schlkopf, IEEE Transactions on Neural Networks, Vol. 12, No. 2, March 2001, the entire contents of both of which are incorporated herein by reference. Also, see “An Introduction to Support Vector Machines and other kernel-based learning methods”, pages 93-124, the content of which pages are incorporated herein by reference in its entirety.

The decision function D(x) is subsequently used to determine the class \overline{ω} to which the data belongs, as shown below:

$$ϖ = \{ \begin{matrix}class 1 & D ( x ) > 0 \\ class 2 & otherwise\end{matrix} \qquad ( 7 )$$

The kernel function, K(xᵢ, x) between the pre-determined support vectors, xᵢ, and the feature vectors x associated with the data undergoing classification may be chosen from a number of known functions to give the best performance during the training phase. The parameters obtained during the training phase together with the kernel function are used to classify new data, as per equation (6) above.

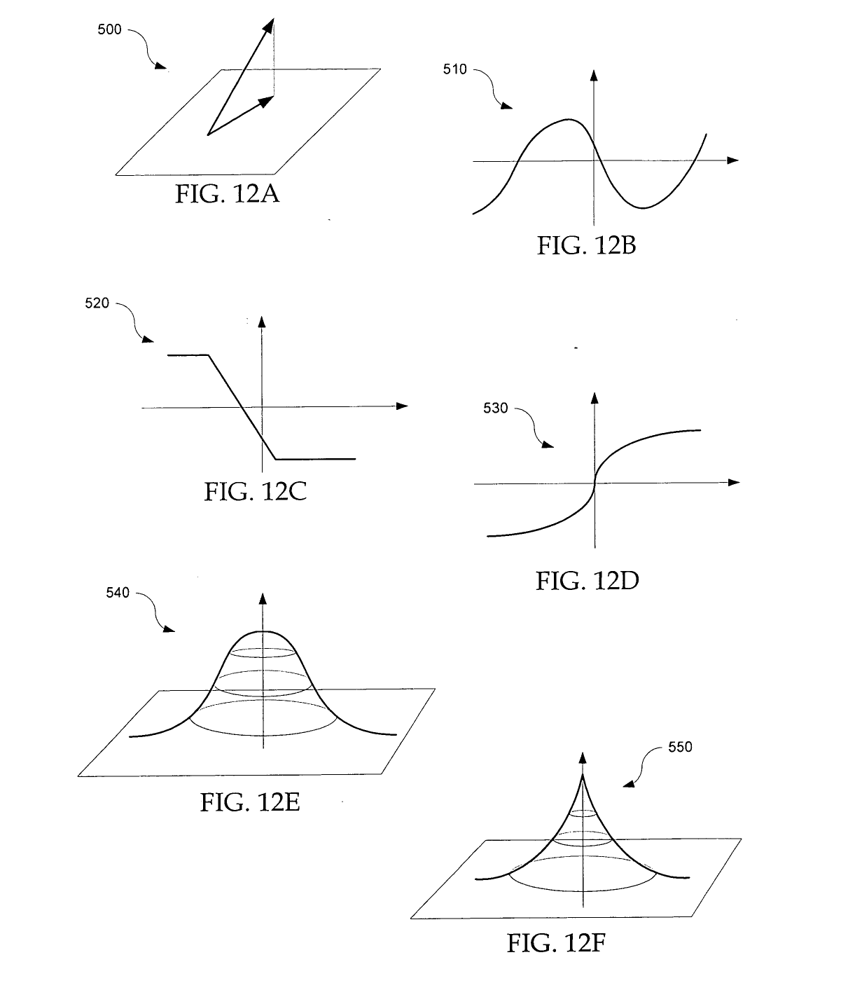

FIGS. 12A-F shows several exemplary kernel functions which may be used to compute decision function D(x) or activation function ƒ(·), shown in above expression (6). It is understood that other kernel functions, not shown, may also be used. Kernel function 500, shown in FIG. 12A, represents a linear transformation from an N-dimensional space to an M-dimensional space, in accordance with the following:

$$[ \begin{matrix}{y}_{1} \\ {y}_{2} \\ ⋮ \\ {y}_{M}\end{matrix} ] = [ \begin{matrix}{u}_{1}^{T} x \\ {u}_{2}^{T} x \\ ⋮ \\ {u}_{M}^{T} x\end{matrix} ]$$

where M is smaller than N, and where uᵢ, x ε R^{N}.

Kernel function 510, shown in FIG. 12B, is a polynomial kernel function, in accordance with the following:
y=α₀+α₁x+α₂x²⁺

Kernel function 520, shown in FIG. 12C, is a piece-wise linear kernel function represented by a number of linear functions over mutually exclusive domains of the entire input domain, in accordance with the following:

$$y = \{ \begin{matrix}{a}_{1} x + {b}_{1} & - ∞ < x \leq {c}_{1} \\ {a}_{2} x + {b}_{2} & {c}_{1} < x \leq {c}_{2} \\ ⋮ & ⋮ \\ {a}_{N} x + {b}_{N} & {c}_{N - 1} < x < ∞\end{matrix}$$

Kernel function 530, shown in FIG. 12D, is a sigmoid kernel function, in accordance with the following:

$$y = \frac{1}{1 + {ⅇ}^{- {w}^{T} x}} .$$

Kernel function 540, shown in FIG. 12E, is a Gaussian radial basis function, in accordance with the following:

$$y = \frac{1}{{( \sqrt{2 π} )}^{N} \sqrt{det C}} {ⅇ}^{- \frac{1}{2} {( x - μ )}^{T} {C}^{- 1} ( x - μ )}$$

Kernel function 550, shown in FIG. 12F, is an exponential radial basis function, in accordance with the following:

$$y = \frac{1}{a} {ⅇ}^{- \frac{\vert x - μ \vert}{b}} .$$

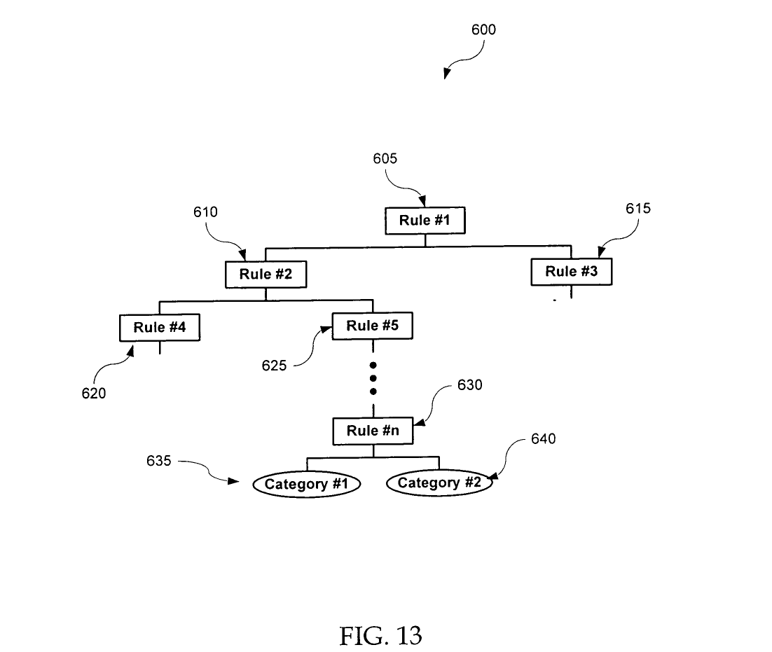

In accordance with some embodiment of the present invention, statistical classifier 130 may include a decision tree classifier. FIG. 13 shows an exemplary decision tree 600 classifier. Decision tree classifiers may be used, for example, when attributes extracted by the feature extraction 120 device are non-numerical or do not have a natural order. For example, the three classes low, medium and high have a natural order and may thus be represented by integers 1, 2, and 3 respectively. In another example, a network intrusion detection system, such as Snort™, available from SourceFire™, 9212 Berger Road, Suite 200, Columbia, Md. 21046] has a number of rules shown below:
alert tcp any any −>192.168.1.0/24 111 (content:“|00 01 86 a5|”; msg:“mountd access”;)

Such rules may be implemented by a decision tree classifier, such as C5, available from RuleQuest Research Pty. Ltd., 30 Athena Avenue, St Ives NSW 2075, Australia. Another decision tree classifier, known as Classification and Regression Trees(CART) is used in machine learning packages such as SAS's Enterprise Miner available from SAS Institute Inc., SAS Campus Drive, Cary, N.C. 27513-2414, USA.

As seen in FIG. 13, tree 600 has a root node 605 defining rule number 1. Depending on the outcome of the decision associated with node 605, transition is made either to node 610 defining rule number 2, or to node 615 defining rule number 3. The remaining transitions of tree 600 are not described herein, but may be seen from FIG. 13.

In one embodiment of the decision tree classifier, the rules are binary rules, resulting in two branches from each node. In another embodiment, each rule may have more than two branches. The leaves of tree 600 identify the class of the data undergoing classification. For example, as seen from FIG. 13, data falling in leaf 635 is classified as belonging to category number 1. Data falling in leaf 640 is classified as belonging to category number 2.

In accordance with some embodiments of the present invention, the statistical classifier may include a Bayesian network classifier that enables the modeling and reasoning about uncertainty of events. A Bayesian Networks allows the incorporation of both subjective and objective probabilities, where objective probabilities are obtained from analysis of training data, and subjective probabilities are predetermined. A typical Bayesian Network consists of multitude of nodes connected by links. The nodes represent observed features within the data, and the links represent conditional probabilities between these features.

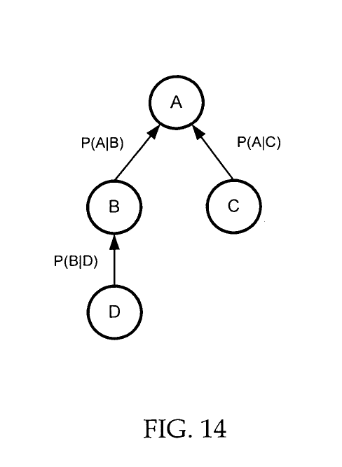

FIG. 14 shows a number of nodes and transitions of a Bayesian network classifier, as known in the prior art. The joint probability of features A, B, C, and E, may be computed as shown below:
p(A,B,C,D)=p(A|B,C)p(B|D)p(D)p(C)
For example, if A, B, C, and D where features used to classify network data as being hostile, then the joint probability p(A, B, C, D) defines the probability that data having those features is hostile. A number of spam filtering software applications have been developed that include Bayesian networks as part of their email analysis, such as Outlook Spam Filter distributed by NovoSoft, 3803 Mt. Bonnel Rd, Austin, 78731, Tex., USA.

In some embodiments, the statistical classifier may be a nearest neighbor classifier. The nearest neighbor classifier stores all labeled training samples in a database and computes a distance metric between the feature vectors of each sample stored in the database and a given feature vector of an unknown data. The training sample closest to the feature vector of the unknown data is used to classify the data.

A number of distance metrics may be used, as known to those skilled in the art. For example, the Euclidean distance is computed as:

$$d ( x , y ) = \sqrt{{\sum }_{i = 1}^{N} {( {x}_{i} - {y}_{i} )}^{2}}$$

for two N-dimensional feature vectors x and y. The Mahalanobis distance, which takes into account the scaling differences and correlations between the features, is computed as,
d(x,y)=\sqrt{(x−y)^{T}C⁻¹(x−y)}
where x and y are N-dimensional feature vectors, and C is the covariance matrix for the data. In some embodiments, the Manhattan distance may be used as shown below:

$$d ( x , y ) = {\sum }_{i = 1}^{N} \vert {x}_{i} - {y}_{i} \vert$$

for two N-dimensional feature vectors x and y.

In some embodiment of the present invention, statistical classifier 130 includes a number of statistical classifiers, known in the art as a mixture of experts classifier (MoE). Each individual classifier of an MoE is adapted to classify a particular subset of data and supply the classification to an arbiter. The arbiter, using the received classifications, decides the classification of the data.

For example, a content filtering application may be built from a number of expert classifiers, each of which may be an expert in classifying different contents. For example one classifier may be more adapted (expert) in classifying spam emails than in classifying pornography. Another classifier may be an expert in classifying pornography than in classifying spam emails. The MoE classifier, using the classification it receives from the two classifiers, is thus able to classify both spam emails and pornography more efficiently to filter the received contents.

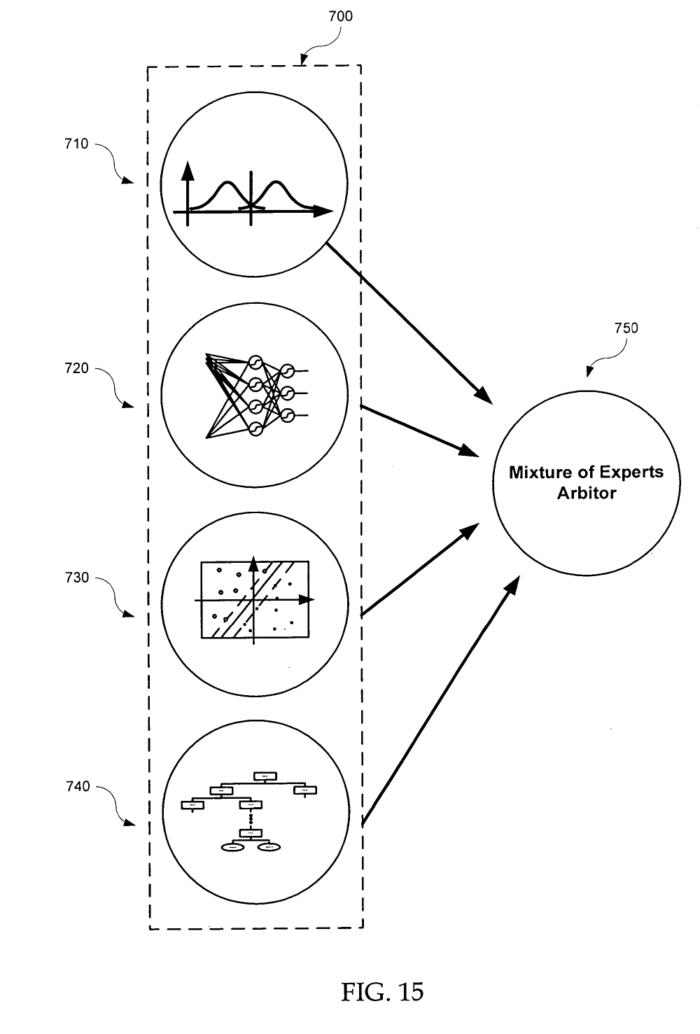

FIG. 15 shows four classifiers 710, 720, 730 and 740 disposed in an MoE 700 and that are configured to supply their classifications to a mixture of experts arbiter (hereinafter alternatively referred to as arbiter) 750. Classifier 710 is shown as being a linear discriminant classifier 850; classifier 720 is shown as being an artificial neural network classifier; classifier 730 is shown as being a support vector machine classifier; and classifier 740 is shown as being a decision tree classifier. Arbiter 650 applies a method of arbitration or voting to the data, i.e., the probabilities returned by each of the constituent classifiers, that it receives from each of the four classifiers to generate a final classification.

In generating the final classification, arbiter 750 may use context information in the form of other features. For example, an MoE arbiter using spam and pornography expert classifiers may use additional context information, such as an indicator variable, to establish if the message is a graphical image, textual, etc., in combining the probabilities provided by each expert. For example, if the message is textual, the arbiter may give more weight to the spam expert classifier; if the message is graphical, the arbiter may give more weight to the pornography expert classifier. It is understood that other MoEs may contain more or fewer classifiers than MoE 700 shown in FIG. 13. It is also understood that each MoE may contain a number of classifiers of the same type, each adapted and thus trained to classify under different conditions, such as when data is from a local area network, or from the Internet, or take different feature vectors.

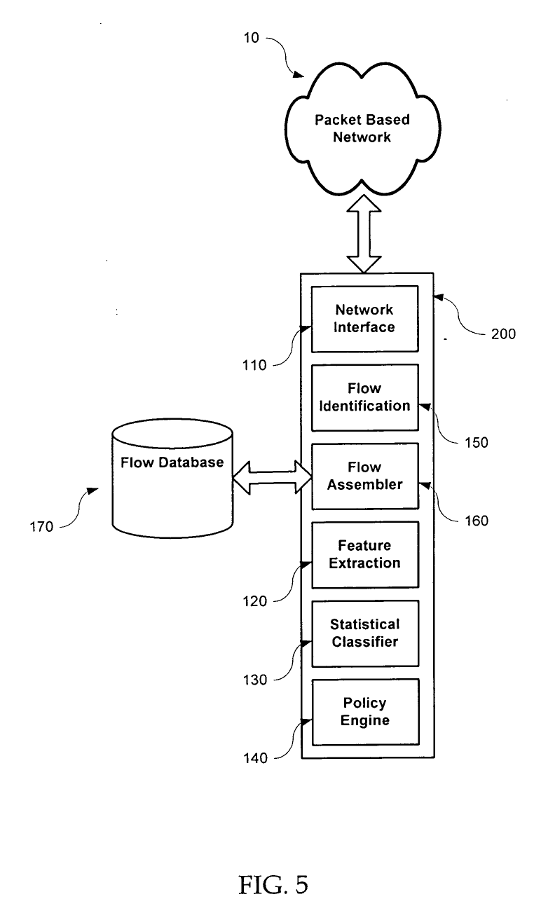

FIG. 16 shows various hardware logic blocks of an exemplary embodiment of a wire-speed statistical classifier (see FIGS. 3-5) 130. Statistical classifier 130 is configured to carry out wire-speed linear projections and non-linear transformations to classify data. Accordingly, the hardware logic blocks of FIG. 16 may be used, e.g., in generating the linear disciminant functions shown equation (2). The hardware logic blocks of FIG. 16 may also be used, e.g., to provide the input layer to a neural network, or the kernel function of a support vector machine. In this exemplary embodiment, content classification is performed in accordance with the following equation:
y=ƒ(w^{T}x−μ) (8)
In the above equation (8), x is an N-dimensional event histogram, w is an N-dimensional weight vector, μ is the mean or threshold, and ƒ(·) represents a non-linear transformation of linearly projected data using kernels, such as those shown above. Statistical classifier 130 is shown as including, in part, a weight look-up table (weight LUT) 805, an adder 810, a multiplexer 815, an accumulator 820, a storage block—such as a register—825, and a non-linear transform logic block 830. Statistical classifier 130 is adapted to receive input data EVENT_ID and generate, in response, output data OUTPUT.

During an initialization cycle, a value represented by −μ in equation (8) above and stored in register 825 is loaded into accumulator 820 via multiplexer (mux) 815 (e.g., when input signal RESET of mux 815 is at a logic low position). In some embodiments, the initial value stored in register 825 may be a negative number. Thereafter, input data EVENT_ID which represents the identification number of an event undergoing classification—and is shown as x in equation (8)—is applied to weight LUT 805. Weight LUT 805 assigns a numerical value—which may be positive or negative and is shown as w in equation (8)—to the event based on the event's identification number and supplies the assigned numerical values to adder 810. Adder 810 adds the numerical value it receives from weight LUT 805 to the numerical value stored in accumulator 820 and supplies the added values to accumulator 820—via multiplexer (mux) 930—which stores the received value. The stored value in accumulator 820 is supplied to non-linear transform logic block 830, which in response, generates output signal OUTPUT, which specifies the class of the received data.

When the features extracted by feature extractor 120 are counts of network events, such as matched patterns, statistical classifier 130, which as described above may be, e.g., a linear discriminiant classifier, an artificial neural network, a support vector machine, or a decision tree classifiers, or any other type of classifier, in performing content classification, such as that associated with equation (8), advantageously performs computations in real-time. Consequently, a network data classifier, in accordance with any of the above embodiments, is configured to perform statistical classifications at wire-speed.

Feature extractor 120, as shown in FIGS. 4-5 and 7-8, may be configured to count the number of times certain patterns occur in the data. For example, assume that in order to detect attempted intrusions, the login patterns are scored by counting the number of times a user enters his username and password during a single session. The feature vector may thus be represented as:

$$x = [ \begin{matrix}username count \\ password count\end{matrix} ]$$

Furthermore, assume that the username count is weighted three times as heavily as the password count. Therefore, a user who may have forgotten and entered the wrong password on the first attempt may be allowed to enter the password again but prevented from making multiple changes to the login username. Assume that weight LUT 805 (FIG. 16) contains a value 3 for username events, and 1 for password events, then the linear discriminant classifier, y, may be represented as:

$$y = {[ \begin{matrix}3 \\ 1\end{matrix} ]}^{T} x - μ$$

where μ controls the threshold of the classifier (the value stored in register 825), such that if y>μ an attempted intrusion is detected. For example, if μ=3.5, then either two attempted usemames, one username together with three password attempts, or four password attempts cause the classifier to detect an intrusion. Those skilled in the art understand that the weights stored in weight LUT 805, and μ may be altered such that different cut-offs are achievable.

As shown in FIGS. 16, the hardware logic blocks of statistical classifier 130 perform computations at wire-speed. Policy engine 140 may subsequently take an action in response to a positive classification, such as detection of an intrusion. It is understood that in, e.g., network intrusion detection applications, or other applications where statistical classification of network data may be used, a larger number of features is typically generated by feature extractor 120, and that the weights stored in weight LUT 805 and threshold values stored in register 825 may be determined by any one of a number of known algorithms during a training phase.

Components such as feature extractor 120, statistical classifier 130, policy engine 140, etc. of each of embodiments, 100, 200, 300 and 350 are programmable and thus may be updated so as to deal with the changing nature of network security threats. Furthermore, a host system may be configured to automatically train on incoming data and thereby adapt one or more of feature extractor 120, statistical classifier 130, and policy engine 140 to improve performance or adapt to changing environments.

The embodiments of the present invention describe above, advantageously perform network data statistical classification in real-time on network packets and at the same rate that the packets are received. These embodiments are configured to perform wire-speed statistical classification of network data in situations where conventional classification of the data using network protocol data embedded in the packets are ineffective. Moreover, these embodiments are configured to perform wire-speed statistical classification of network data in situations where the measure of uncertainty about the class to which the data belongs renders conventional classifiers ineffective. Because, in accordance with the embodiments of the present invention, more detailed and comprehensive examination of the network data and more sophisticated classification algorithms are deployed, higher accuracy of classification and hence more robust network systems and network system applications are achieved.

The above embodiments of the present disclosure are illustrative and not limitative. The above embodiments of the present invention are not intended to be limited to the embodiments shown herein but are to be accorded the widest scope consistent with the principles and novel features disclosed herein. For example, the functionality above may be combined or further separated, depending upon the embodiment. Certain features may also be added or removed. additionally, the particular order of the features recited is not specifically required in certain embodiments, although may be important in others. The sequence of processes can be carried out in computer code and/or hardware depending upon the embodiment. One of ordinary skill in the art would recognize many other variations, modifications, and alternatives.

Those skilled in the art understand that various adaptations and modifications of the above described embodiments may be configured without departing from the scope of the invention. For example, other linear or nonlinear transformations, kernel functions, different network and system interfaces may be used, or modifications may be made to the packet processing procedure. Moreover, the described wire-speed statistical network classifiers may be implemented by separate integrated circuits, or by a single integrated circuit. The present system may also be applied to a variety of applications including intrusion detection, intrusion prevention, firewall, content filtering, access control, antivirus, network monitoring, traffic filtering, spam filtering, content classification, application-level switching, bandwidth/quality of service management, surveillance, and XML web services, among others.

The invention is not limited by the type or size of the received data. Nor is it limited by the manner or means with which data is carried, packets or otherwise. The invention is not limited by the type of network protocol to which the received data, packets or otherwise, conform. Nor is the invention limited by the class of data disposed in and carried by packets or otherwise. Other additions, subtractions, deletions, and modifications may be made without departing from the scope of the present invention as set forth in the appended claims.

1. A network data classifier configured to statistically classify data and comprising:
a network interface configured to receive packets carrying the data;
a feature extraction hardware block coupled to the network interface and configured to extract at least one feature from the received data;
a statistical classifier coupled to the feature extraction and configured to statistically classify the data in accordance with the at least one extracted feature; and
a policy engine coupled to the statistical classifier and configured to define a rule corresponding to the data class, wherein the statistical classifier is further configured to statistically classify the data at a same rate at which the network interface receives the packets.

2. The network classifier of claim 1 wherein the rate at which the packets are received is greater than or equal to 100 Mbits/sec.

3. The network classifier of claim 1 further comprising:
a flow identifier coupled to the network interfaces and configured to identifying a flow to which each of the received packets belongs;
a flow assembler coupled to the flow identifier and configured to reorder the received packets such that the order of the reordered packets matches the order in which they were transmitted; and
a flow database configured to the flow assembler and configured to maintain a record for each identified flow.

4. The network classifier of claim 3 wherein the record for each identified flow includes at least one of an identification number, source and destination addresses of the received packets, protocol identification number, information used by the feature extraction hardware block and information used by the statistical classifier.

5. The network classifier of claim 4 further comprising:
a host interface configured to receive the packets from a host system.

6. The network classifier of claim 4 further comprising:
a host interface configured to receive the data from a host system.

7. The network classifier of claim 5 wherein the host interface is coupled to a device selected from a group consisting of microprocessor and network processor.

8. The network classifier of claim 7 wherein the host system is selected from a group consisting of firewall, router, switch, network appliance, security system, anti-virus system, anti-spam system, intrusion detection system, content filtering system, mail server, web server, quality of service provisioner, and gateway.

9. The network classifier of claim 8 wherein the host system is coupled to at least one of the flow identifier, the flow assembler, the feature extraction hardware block, the statistical classifier, and the flow database via one or more application programming interface.

10. The network classifier of claim 1 wherein the feature extractor is programmable.

11. The network classifier of claim 1 wherein the statistical classifier is programmable.

12. The network classifier of claim 1 wherein the policy engine is programmable.

13. The network classifier of claim 1 wherein the received data is one of messages, files, streams, documents, web pages, and e-mails.

14. The network classifier of claim 1 wherein the network interface is configured to interface with at least one of an Ethernet network, a SONET network, and an ATM network.

15. The network classifier of claim 1 wherein the packets are received via an Internet Protocol (IP) network.

16. The network classifier of claim 1 wherein the feature extraction hardware block is configured to match extract features against a database of textual patterns.

17. The network classifier of claim 3 wherein the statistical classifier is configured to correlate events between one or more data flows

18. The network classifier of claim 11 wherein the statistical classifier includes at least one of linear discriminant classifier, artificial neural network classifier, support vector machine classifier, Bayesian network classifier, decision tree classifier; and nearest neighbor classifier.

19. The network classifier of claim 18 wherein the artificial neural network classifier is configured to operate in accordance with an activation function selected from the group consisting of sigmoid function, hyperbolic tan function, Gaussian radial basis function, exponential radial basis function, and a non-linear function.

20. The network classifier of claim 18 wherein the support vector machine classifier is configured to operate in accordance with a kernel function selected from a group consisting of a linear projection function, polynomial function, piece-wise linear function, sigmoid function, Gaussian radial basis function, exponential radial basis function, and a non-linear transformation function.

21. The network classifier of claim 18 wherein the nearest neighbor classifier is configured to operate in accordance with a distance metric selected from a group consisting of Euclidean distance, Mahalanobis distance, and Manhattan distance.

22. The network classifier of claim 18 wherein the statistical classifier further generates a probability associated with a multitude of classes for the received data.

23. The network classifier of claim 22 wherein the statistical classifier classifies the received data for at least one of the applications selected from a group consisting of intrusion detection, content filtering, anti-spam, anti-virus, bandwidth management, quality of service provisioning, and network monitoring.

24. The network classifier of claim 1 wherein the at least one feature is selected from a group consisting of indicator vector, histogram, multitude of statistics associated with the data, mathematical transformation, timing information, and network events.

25. The network classifier of claim 3 wherein the feature extraction hardware block stores a history of the data it receives in the flow database, said history being used to extract the features from the received data.

26. The apparatus of claim 3 furthermore comprising:
a data flow multiplexer, the data flow multiplexer being coupled to the one or more of a plurality of network interfaces, the data flow multiplexer coupled to the one or more of a plurality of feature extraction devices, the data flow multiplexer providing for context switching between one or more of a plurality of data flows; and
a data flow context database, the data flow context database coupled to the data flow multiplexer, the data flow context database providing for retaining of state of said one or more of a plurality of data flows for said context switching.

27. The apparatus of claim 1, wherein said statistical classifier further comprises:
a lookup table configured to store weights for a multitude of events associated with the network data;
an adder coupled to add the weights it receives from the look-up table;
a register configured to store a value;
an accumulator; and
a multiplexer configured to deliver to the accumulator one of the added weights it receives from the adder at its first input terminal and the value it receives from the register at its second input terminal, the accumulator further configured to supply a summation of the added weights to the adder.

28. The integrated circuit of claim 27 furthermore comprising:
a hardware logic block configured to apply one of linear and non-linear functions to the summation stored in the accumulator.

29. The integrated circuit of claim 28 wherein the hardware logic block is configured to apply a non-linear function to the summation stored in the accumulator using lookup table.

30. The integrated circuit of claim 28 wherein the hardware logic block is formed in a programmable device.

31. The integrated circuit of claim 28 wherein the register is programmable.

32. The integrated circuit of claim 28 wherein the hardware logic block is programmable.

33. An integrated circuit configured to perform wire-speed computations for use in statistical classification of network data, the integrated circuit comprising:
a lookup table configured to store weights for a multitude of events associated with the network data;
an adder coupled to add the weights it receives from the look-up table;
a register configured to store a value;
an accumulator; and
a multiplexer configured to deliver to the accumulator one of the added weights it receives from the adder at its first input terminal and the value it receives from the register at its second input terminal, the accumulator further configured to supply a summation of the added weights to the adder.

34. The integrated circuit of claim 33 wherein said integrated circuit is a field programmable gate array.

35. The integrated circuit of claim 33 furthermore comprising:
a hardware logic block configured to apply a non-linear function to the summation stored in the accumulator.

36. The integrated circuit of claim 35 wherein the hardware logic block is configured to apply a non-linear function to the summation stored in the accumulator using lookup table.

37. The integrated circuit of claim 35 wherein the hardware logic block is formed in a programmable device.

38. The integrated circuit of claim 35 wherein the register is programmable.

39. The integrated circuit of claim 35 wherein the hardware logic block is programmable.

40. A method for statistically classifying data, the method comprising:
receiving packets carrying the data;
extracting at least one feature from the received data;
statistically classifying the data in accordance with the at least one extracted feature and at a same rate at which the packets are received; and
applying a rule corresponding to the data class.

41. The method of claim 40 wherein the rate at which the packets are received is greater than or equal to 100 Mbits/sec.

42. The method of claim 40 further comprising:
identifying a flow to which each of the received packets belongs;
reordering the received packets such that the order of the reordered packets matches the order in which they were transmitted; and
maintaining a record for each identified flow.

43. The method of claim 42 wherein the record for each identified flow includes at least one of an identification number, source and destination addresses of the received packets, protocol identification number, information used for extracting the at least one feature extractor and information used to statistically classify the data.

44. The method of claim 43 further comprising:
receiving the packets from a host system.

45. The method of claim 43 further comprising:
receiving the data from a host system.

46. The method of claim 44 wherein the host system is selected from a group consisting of microprocessor and a network processor.

47. The method of claim 46 wherein the host system is selected from a group consisting of firewall, router, switch, network appliance, security system, anti-virus system, anti-spam system, intrusion detection system, content filtering system, mail server, web server, quality of service provisioner, and gateway.

48. The method of claim 46 further comprising:
coupling the host system to one or more application programming interfaces.

49. The method of claim 40 wherein the received data is one of messages, files, streams, documents, web pages, and e-mails.

50. The method of claim 40 wherein the packets are received via one of an Ethernet network, a SONET network, and an ATM network.

51. The method of claim 40 wherein the packets are received via an Internet Protocol (IP) network.

52. The method of claim 40 further comprising:
matching the extract features against a database of textual patterns.

53. The method of claim 42 further comprising:
correlating events between one or more data flows.

54. The method of claim 53 wherein the statistically classifying of the data is carried out using a statistical classifier that includes at least one of linear discriminant classifier, artificial neural network classifier, support vector machine classifier, Bayesian network classifier, decision tree classifier; and nearest neighbor classifier.

55. The method of claim 54 wherein the artificial neural network classifier is configured to operate in accordance with an activation function selected from the group consisting of sigmoid function, hyperbolic tan function, Gaussian radial basis function, exponential radial basis function, and a non-linear function.

56. The method of claim 54 wherein the support vector machine classifier is configured to operate in accordance with a kernel function selected from a group consisting of a linear projection function, polynomial function, piece-wise linear function, sigmoid function, Gaussian radial basis function, exponential radial basis function, and a non-linear transformation function.

57. The method of claim 54 wherein the nearest neighbor classifier is configured to operate in accordance with a distance metric selected from a group consisting of Euclidean distance, Mahalanobis distance, and Manhattan distance.

58. The method of claim 54 wherein the statistical classifier further generates a probability associated with a multitude of classes for the received data.

59. The method of claim 58 wherein the statistical classifier classifies the received data for at least one of the applications selected from a group consisting of intrusion detection, content filtering, antivirus, bandwidth management, quality of service provisioning, anti-spam, and network management.

60. The method of claim 40 wherein the at least one feature is selected from a group consisting of indicator vector, histogram, multitude of statistics associated with the data, mathematical transformation, timing information, and network events.

61. The method of claim 42 further comprising:
stores a history of the received data, said history being used to extract the features from the received data.

62. The method of claim 42 further comprising:
multiplexing the data so as to provide for context switching between one or more of a plurality of data flows; and
retaining states of said one or more of a plurality of data flows for said context switching.
